(19) United States
(12) Patent Application Publication
(10) Pub. No.: US 2013/0229359 A1
(43) Pub. Date: Sep. 5, 2013

(54) ELECTRONIC APPARATUS

(71) Applicants: Ren-Hung Wang, Taichung City (TW); Jun-Yong Zhang, Shenzhen (CN); Ming-Jie Hung, Taoyuan County (TW); Lien-Hsin Lee, Taipei City (TW); Chao-Sung Li, Hsinchu County (TW)

(72) Inventors: Ren-Hung Wang, Taichung City (TW); Jun-Yong Zhang, Shenzhen (CN); Ming-Jie Hung, Taoyuan County (TW); Lien-Hsin Lee, Taipei City (TW); Chao-Sung Li, Hsinchu County (TW)

(73) Assignee: SHUN ON ELECTRONIC CO., LTD., Hsinchu County (TW)

(21) Appl. No.: 13/411,634

(22) Filed: Mar. 5, 2012

(51) Int. Cl. G06F 3/041

(52) U.S. Cl. 345/173

(57) ABSTRACT

An electronic apparatus including a display module and a touch panel is provided. The display module has at least one first connector. The touch panel is disposed on the display module and has a second connector, in which the second connector is plugged into the corresponding first connector to make the touch panel assembled onto and electrically connected to the display module.

### BACKGROUND OF THE INVENTION

1. Field of the Invention

The invention generally relates to an electronic apparatus, and more particularly, to an electronic apparatus with a touch panel.

2. Description of Related Art

In modern information society, human beings have increasing dependence on the consumer electronic devices. Regardless of mobile phones, personal digital assistant (PDA) or tablet PC, they can be seen everywhere around us in life. Thus, the consumer electronic apparatus and our modern daily life are inseparable from each other. In order to achieve more convenient, smaller and more compact and more user-friendly usage benefits, many products have changed their input devices from the traditional ones such as keyboard or mouse into the use of touch screen as input device.

In general, the touch screen comprises a touch panel and a display panel. Since the design of a touch panel must consider the appearance thereof, so that the touch panel and the display panel are separately assembled onto a product. However, the existing touch panel mostly is fixed on the product in adhesive method. Therefore, when the assembled staff needs to assemble or disassemble/replace a touch panel, it often causes the touch panel to shift the light-emitting during assembling or to generate destructive damage during disassembling or replacing. In addition, the efficiency of assembling or disassembling with the traditional method is poor as well.

### SUMMARY OF THE INVENTION

Accordingly, the invention is directed to an electronic apparatus, in which the touch panel thereof can be simply and quickly assembled onto or detached from the display module.

The invention provides an electronic apparatus which includes a display module and a touch panel. The display module has at least one first connector. The touch panel is disposed on the display module and has a second connector, in which the second connector is plugged into the corresponding first connector to make the touch panel assembled onto and electrically connected to the display module.

In an embodiment of the present invention, the above-mentioned display module includes a liquid crystal display module (LCM), a plasma display module or an organic light-emitting display (OLED).

In an embodiment of the present invention, the above-mentioned touch panel includes a resistive touch panel, a capacitive touch panel, an optical touch panel, a surface-acoustic-wave touch panel or an electromagnetic touch panel.

In an embodiment of the present invention, the above-mentioned first connector and second connector respectively include a USB connector (universal serial bus connector).

In an embodiment of the present invention, at least one of the above-mentioned first connector and second connector is a retractable plug connector.

In an embodiment of the present invention, at least one of the above-mentioned first connector and second connector is a receptacle connector.

In an embodiment of the present invention, the above-mentioned electronic apparatus further includes a cover detachably disposed on the touch panel, in which the cover has an opening and the opening exposes out a touch-control area of the touch panel.

In an embodiment of the present invention, the above-mentioned touch panel further includes a wireless transmission unit, a side-edge of the cover has an accommodation hole, and the accommodation hole is disposed correspondingly to the wireless transmission unit and exposes out the wireless transmission unit.

In an embodiment of the present invention, the above-mentioned display module includes a frame, a display panel and a backlight module. The first connector is disposed on the frame. The display panel is disposed in the frame and electrically connected to the first connector. The backlight module is disposed in the frame and located between the frame and the display panel.

In an embodiment of the present invention, the above-mentioned frame has at least one first locking portion and the cover has at least one second locking portion, and the first locking portion is suitable to lock the corresponding second locking portion to fix the cover on the display module.

In an embodiment of the present invention, at least one of the above-mentioned first locking portion and second locking portion is a latch tenon.

In an embodiment of the present invention, at least one of above-mentioned first locking portion and second locking portion is a latch slot.

Based on the description above, the invention uses a connection plugging way to make the touch panel assembled onto and electrically connected to the display module. In comparison with the prior art where the touch panel and the product are fixed by using adhering way, the electronic apparatus of the invention has better assembling efficiency. In addition, when the electronic apparatus gets damage, the maintenance staff can easily detach the touch panel from the display module so as to avoid the same destructive damage as the conventional touch panel during detaching or replacing. In short, the electronic apparatus of the invention has better maintenance efficiency.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 schematic cross-sectional diagram of an electronic apparatus according to an embodiment of the invention.

FIG. 2 is a three-dimensional exploded diagram of an electronic apparatus according to another embodiment of the invention.

### DESCRIPTION OF THE EMBODIMENTS

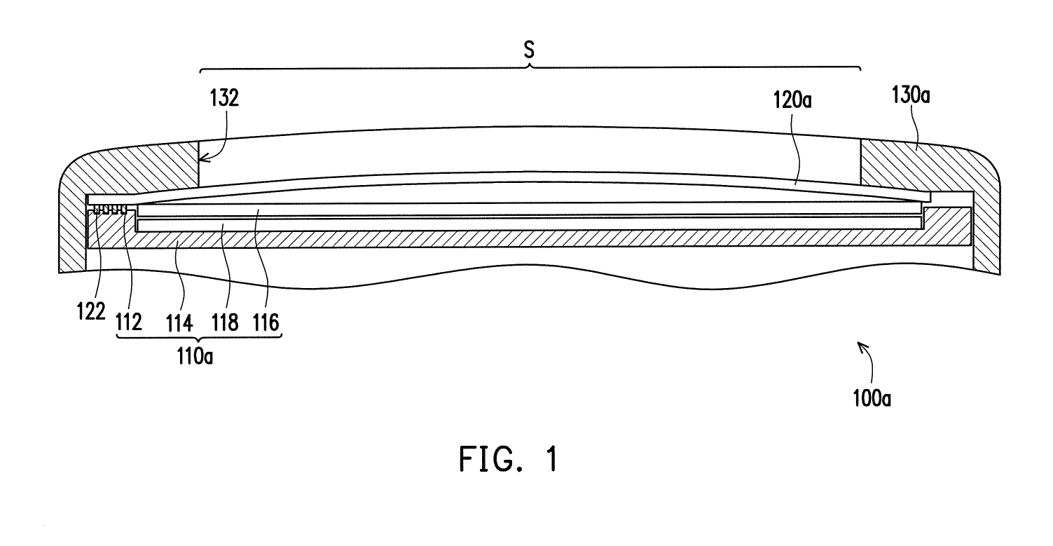

FIG. 1 schematic cross-sectional diagram of an electronic apparatus according to an embodiment of the invention. Referring to FIG. 1, in the embodiment, an electronic apparatus 100a includes a display module 110a and a touch panel 120a. In more details, the display module 110a has at least one first connector 112 (in FIG. 1, only one, as an example, is shown) and the display module 110a comprises a frame 114, a display panel 116 and a backlight module 118. The first connector 112 is disposed on the frame 114, the display panel 116 is disposed in the frame 114 and electrically connected to the first connector 112, and the backlight module 118 is disposed in the frame 114 and located between the frame 114 and the display panel 116. The display module 110a herein is, for example, a liquid crystal display module (LCM), a plasma display module or an organic light-emitting display (OLED), which the invention is not limited to. The first connector 112 is, for example, a USB connector (universal serial bus connector), and preferably, for example, a receptacle connector.

The touch panel 120a is disposed on the display module 110a and has a second connector 122. In particular, the second connector 122 is plugged into the corresponding first connector 112 to make the touch panel 120a assembled onto and electrically connected (for example, in series connection) to the display module 110a. In other words, the touch panel 120a and the display module 110a are assembled only by using the second connector 122 and the first connector 112 therebetween. The touch panel 120a herein is, for example, a resistive touch panel, a capacitive touch panel, an optical touch panel, a surface-acoustic-wave touch panel or an electromagnetic touch panel, and the user can replace the required touch panel depending on the application need. The second connector 122 is, for example, a USB connector (universal serial bus connector), and preferably, for example, a retractable plug connector.

It should be noted that in the embodiment the first connector 112 is a receptacle connector and the second connector 122 is a retractable plug connector, however, the invention does not limit the forms of the first connector 112 and the second connector 122. In other embodiments, the second connector 122 can be a receptacle connector and the first connector 112 is a retractable plug connector, which still falls in the scheme and the protected scope of the invention.

In addition, the electronic apparatus 100a of the embodiment can further include a cover 130a, wherein the cover 130a is detachably disposed on the touch panel 120a and encloses around the display module 110a. The cover 130a has an opening 132 and the opening 132 exposes out a touch-control area S of the touch panel 120a.

Since in the embodiment, the second connector 122 is plugged into the first connector 112 to make the touch panel 120a assembled onto and electrically connected to the display module 110a, in comparison with the prior art where the touch panel and the product are fixed by using adhering way, the electronic apparatus 100a of the invention has better assembling efficiency and the user can replace the required touch panel 120a (for example, by using a liquid crystal display module, a plasma display module or an organic light-emitting display) depending on the application need, which greatly advances the applications of the electronic apparatus 100a. In addition, when the electronic apparatus 100a gets damage, after detaching the cover 130a, the maintenance staff can easily detach the touch panel 120a from the display module 110a so as to avoid the same destructive damage as the conventional touch panel 120a during detaching or replacing. Therefore, the electronic apparatus 100a of the invention has better maintenance efficiency. Moreover, since the cover 130a of the embodiment is detachably disposed on the touch panel 120a, the user can preferably replace the cover 130a with different colors or patterns so that the electronic apparatus 100a has a nicer appearance to meet individuation requirement.

It should be noted that the component notations and partial details of the structures hereinafter provided in the embodiments can be the same as or similar to the previous embodiment, wherein the same notations represent the same or similar components while the repeated same details are omitted, which can refer to the previous embodiment.

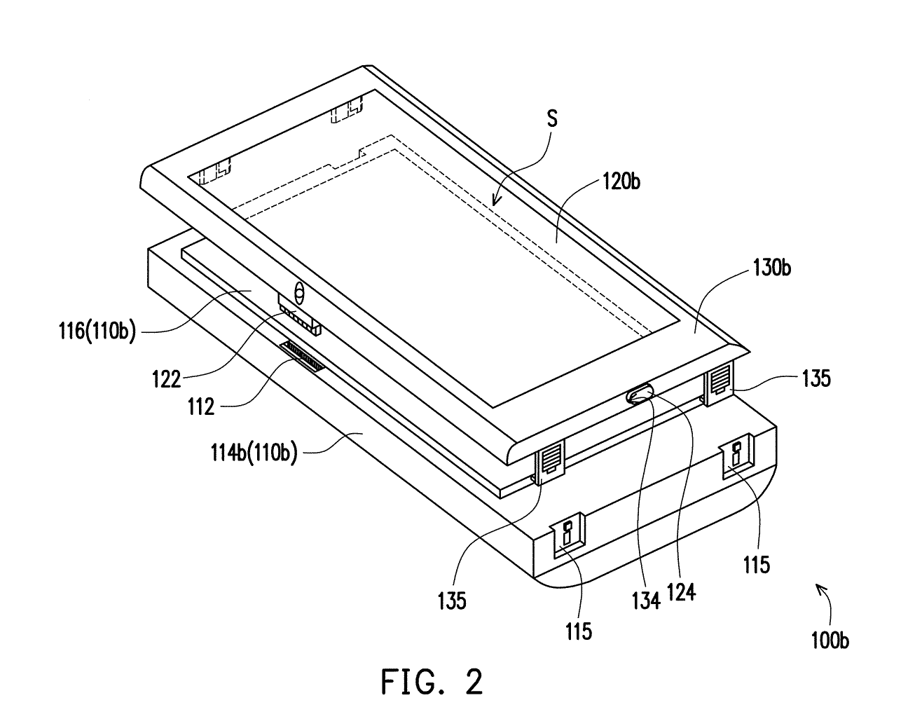

FIG. 2 is a three-dimensional exploded diagram of an electronic apparatus according to another embodiment of the invention. For description simplicity, some parts of the display module 110b in FIG. 2 are omitted. Referring to FIG. 2, the electronic apparatus 100b of the embodiment is similar to the electronic apparatus 100a of FIG. 1, except that the touch panel 120b further includes a wireless transmission unit 124 and an accommodation hole 134 is located at a side-edge of the cover 130b, in which the accommodation hole 134 is disposed correspondingly to the wireless transmission unit 124 and exposes out the wireless transmission unit 124. When the touch panel 120b is detached from the display module 110b, the second connector 122 (for example, a retractable plug connector) can be saved away to directly use the wireless transmission unit 124 to switch the cable connection mode into the wireless RF connection mode, which enables the touch panel 120b having function of tablet, keyboard or mouse. That is to say, in addition to be used with the display module 110b, the touch panel 120b can be used alone.

The frame 114b of the embodiment can further have at least one first locking portion 115 (in FIG. 2, four ones are shown) and the cover 130b can further have at least one second locking portion 135 (in FIG. 2, four ones are shown), in which the first locking portion 115 is suitable to lock the corresponding second locking portion 135 to fix the cover 130b onto the display module 110b. The first locking portion 115 and the second locking portion 135 herein are, for example, respectively a latch slot and a latch tenon.

It should be noted that in the embodiment the first locking portion 115 is a latch slot and the second locking portion 135 is a latch tenon, which the invention is not limited to. In other embodiments, the first locking portion 115 and the second locking portion 135 can have other forms, for example, the second locking portion 135 is a latch slot and the first locking portion 115 is a latch tenon; or the first locking portion 115 and the second locking portion 135 adopt other structure designs with the same positioning effect, which still falls in the scheme and the protected scope of the invention.

In summary, in the invention, a plugging way of connectors is used to make the touch panel assembled onto and electrically connected to the display module and the cover is detachably disposed on the touch panel. In comparison with the prior art where the touch panel and the product are fixed by using adhering way, the electronic apparatus of the invention has better assembling efficiency and the user can easily replace the required touch panel depending on the application need, which greatly advances the applications of the electronic apparatus. In addition, when the electronic apparatus gets damage, after detaching the cover, the maintenance staff can easily detach the touch panel from the display module so as to avoid the same destructive damage as the conventional touch panel during detaching or replacing. Therefore, the electronic apparatus of the invention has better maintenance efficiency. Moreover, since the cover of the embodiment is detachably disposed on the touch panel, the user can preferably replace the cover with different colors or patterns so that the electronic apparatus has a nicer appearance to meet individuation requirement.

It will be apparent to those skilled in the art that various modifications and variations can be made to the structure of the invention without departing from the scope or spirit of the invention. In view of the foregoing, it is intended that the invention covers modifications and variations of this invention provided they fall within the scope of the following claims and their equivalents.

What is claimed is:

1. An electronic apparatus, comprising:
a display module, having at least one first connector; and
a touch panel, disposed on the display module and having a second connector, wherein the second connector is plugged into the corresponding first connector to make the touch panel assembled onto and electrically connected to the display module.

2. The electronic apparatus as claimed in claim 1, wherein the display module comprises a liquid crystal display module (LCM), a plasma display module or an organic light-emitting display (OLED).

3. The electronic apparatus as claimed in claim 1, wherein the touch panel comprises a resistive touch panel, a capacitive touch panel, an optical touch panel, a surface-acoustic-wave touch panel or an electromagnetic touch panel.

4. The electronic apparatus as claimed in claim 1, wherein the first connector and the second connector respectively comprise a USB connector (universal serial bus connector).

5. The electronic apparatus as claimed in claim 4, wherein at least one of the first connector and the second connector is a retractable plug connector.

6. The electronic apparatus as claimed in claim 5, wherein at least one of the first connector and the second connector is a receptacle connector.

7. The electronic apparatus as claimed in claim 1, further comprising a cover, detachably disposed on the touch panel, wherein the cover has an opening and the opening exposes out a touch-control area of the touch panel.

8. The electronic apparatus as claimed in claim 7, wherein the touch panel further comprises a wireless transmission unit, a side-edge of the cover has an accommodation hole, and the accommodation hole is disposed correspondingly to the wireless transmission unit and exposes out the wireless transmission unit.

9. The electronic apparatus as claimed in claim 7, wherein the display module comprises:
a frame, on which the first connector is disposed;
a display panel, disposed in the frame and electrically connected to the first connector; and
a backlight module, disposed in the frame and located between the frame and the display panel.

10. The electronic apparatus as claimed in claim 9, wherein the frame has at least one first locking portion and the cover has at least one second locking portion, and the first locking portion is suitable to lock the corresponding second locking portion to fix the cover on the display module.

11. The electronic apparatus as claimed in claim 10, wherein at least one of first locking portion and the second locking portion is a latch tenon.

12. The electronic apparatus as claimed in claim 11, wherein at least one of first locking portion and the second locking portion is a latch slot.
